(19) United States
(12) Patent Application Publication
(10) Pub. No.: US 2020/0347886 A1
(43) Pub. Date: Nov. 5, 2020

(54) METHOD FOR OPERATING A BEARING WITH AT LEAST A FIRST ENERGY SUPPLY MODULE AND A SECOND ENERGY SUPPLY MODULE

(71) Applicant: Schaeffler Technologies AG & Co. KG, Herzogenaurach (DE)

(72) Inventors: Martin Kram, Gerolzhofen (DE); Tomas Smetana, Yokohama (JP); Michel Gnaba, Yokohama (JP); Masato Izumi, Meguro-ku Tokyo (JP)

(73) Assignee: Schaeffler Technologies AG & Co. KG, Herzogenaurach (DE)

(21) Appl. No.: 16/961,972

(22) PCT Filed: Jan. 17, 2019
(86) PCT No.: PCT/DE2019/100044

§ 371 Date: Jul. 14, 2020

(30) Foreign Application Priority Data
Jan. 18, 2018 (DE) 10 2018 101 062.1

(51) Int. Cl. F16C 41/00; F16C 19/52; F16C 17/12

(52) U.S. Cl. CPC F16C 41/004; F16C 17/12; F16C 19/522

(57) ABSTRACT

A method for operating a bearing (10), in particular roller bearing or sliding bearing or linear bearing, with at least a first energy supply module (1, 2, 3, 4) and a second energy supply module (1, 2, 3, 4), wherein a first control unit of the first energy supply module (1, 2, 3, 4) and a second control unit of the second energy supply module (1, 2, 3, 4) are configured to control outputting of energy of the respective energy supply module (1, 2, 3, 4) according to a predefined supply strategy, wherein the first control unit and/or the second control unit receive/receives a supply request and controls the outputting of energy by the respective energy supply module (1, 2, 3, 4) as a function of the supply request and the predefined supply strategy.

### CROSS-REFERENCE TO RELATED APPLICATIONS

This application is the U.S. National Phase of PCT Appln. No. PCT/DE2019/100044 filed Jan. 17, 2019, which claims priority to 10 DE 2018 101 062.1 filed Jan. 18, 2018, the entire disclosures of which are incorporated by reference herein.

### TECHNICAL FIELD

The disclosure relates to a method for operating a bearing, in particular a roller bearing or sliding bearing or linear bearing, with at least a first energy supply module and a second energy supply module. The disclosure further relates to such a bearing, in particular a roller bearing or sliding bearing or linear bearing.

### BACKGROUND

Bearings often have sensors or actuators for the operation of which electrical energy must be provided. For example, DE 10 2015 202 130 A1 describes a kit for forming a modularly constructed roller bearing having function modules that can measure bearing condition variables and/or activate certain functions. To supply these function modules, the kit has energy supply modules that can be provided in the bearing, depending on the application, such as an energy harvesting module or an accumulator module.

In such bearings, individual energy supply modules are often unable to provide the electrical energy required to operate all of the function modules of the bearing.

### SUMMARY

Against this background, it is desirable to ensure the reliability of the energy supply even with high energy requirements by means of a method that is scalable with little effort.

The object is achieved by a method for operating a bearing, in particular a roller bearing or sliding bearing or linear bearing, with at least a first energy supply module and a second energy supply module, wherein a first control unit of the first energy supply module and a second control unit of the second energy supply module are configured to control energy output of the respective energy supply module according to a specified supply strategy, wherein the first control unit and/or the second control unit receives a supply request and, depending on the supply request and the specified supply strategy, controls the delivery of energy by the respective energy supply module.

The bearing has at least two energy supply modules for supplying electrical energy so that energy can optionally be delivered from one or both of these energy supply modules. If necessary, a high energy requirement can therefore be met. The energy supply modules each include a control unit that is configured to control the delivery of energy by the respective energy supply module in accordance with a predetermined supply strategy and depending on a supply request. In this respect, the energy supply modules can control the delivery of energy autonomously. There is no need for a superordinate unit for the energy supply modules to take over control of the individual energy supply modules, so that scaling the method, for example by changing the number of energy supply modules, may be done with little effort.

The control units can be configured, for example, during the manufacture of the bearing, in particular during the packaging of the bearing with the energy supply modules. If the control unit is designed to be programmable, for example, the supply strategy can be stored in the control unit as a program or data code. Alternatively, the supply strategy can be determined by the structure of the hardware of the control unit. The supply strategy can be represented as a table and/or algorithm.

The first energy supply module and the second energy supply module are preferably designed as an energy generation module, for example as an energy harvesting module. In this context, an energy harvesting module is understood to mean an energy generation module that is designed to generate, in particular, small amounts of electrical energy from the rotational movement of the bearing and/or the ambient temperature of the bearing and/or from vibrations of the bearing. Alternatively, the first energy supply module can be designed as an energy generation module and the second energy supply module as an energy storage module, for example as an accumulator module or battery module or capacitor module.

According to a preferred embodiment, it is provided that the first energy supply module and the second energy supply module are designed differently. For example, the first energy supply module can be a first energy harvesting module and the second energy supply module can be a second energy harvesting module, the two energy harvesting modules generating electrical energy through different physical effects.

The supply request preferably comprises a voltage requirement and/or a current requirement and/or an energy requirement and/or a power requirement. For example, a target voltage can be specified as the voltage requirement, which target voltage is required for operating a certain load. Likewise, a target current can be specified as a current requirement and/or a target energy as an energy specification and/or a target power as a power specification.

The supply request is particularly preferably a common supply request which is received identically by the first control unit of the first energy supply module and the second control unit of the second energy supply module.

According to an advantageous embodiment, the first control unit and/or the second control unit receives the supply request from an interface module or from a load, in particular a load module, of the bearing.

The first control unit and/or the second control unit preferably sets an output voltage and/or an output current to control the delivery of energy by the respective energy supply module.

An advantageous embodiment provides that the first energy supply module and the second energy supply module are connected via a common supply bus, over which the first energy supply module and the second energy supply module can deliver energy. One or more loads can be connected to such a supply bus. Alternatively or additionally, it can be provided that the first energy supply module and the second energy supply module are connected via a common communication bus, so that the first energy supply module and the second energy supply module and possibly further modules can exchange information via this communication bus.

According to an advantageous embodiment, it is provided that the first energy supply module determines first supply status information, which is characteristic of the first energy supply module, and transmits the first supply status information to the second energy supply module, wherein the second control unit of the second energy supply module additionally controls the delivery of energy depending on the first supply status information. The first supply status information can contain, for example, an indication of which voltage or which current or which power the energy supply module is currently providing. Alternatively, or additionally, the first supply status information can contain status information which is dependent on the received supply request, for example an indication of what percentage of the required amount of energy or power can be provided by the first energy supply module. The second energy supply module preferably determines second supply status information, which is characteristic of the second energy supply module, and transmits the second supply status information to the first energy supply module, wherein the first control unit of the first energy supply module additionally controls the delivery of energy depending on the second supply status information. In addition, supply status information of further energy supply modules can be used for control in the respective control units.

In one embodiment that has proven to be advantageous, the first energy supply module receives a prediction value which is characteristic of the future behavior of the first energy supply module and transmits the prediction value to the second energy supply module, wherein the second control unit additionally controls the output of energy depending on the prediction value. The prediction value is preferably determined depending on a measurement of a condition of the respective energy supply module measurement of a voltage and/or of a current of the energy supply module.

A preferred embodiment provides that the first control unit and/or the second control unit receives a supply request and controls the reception of energy by the respective energy supply module depending on the supply request and the specified supply strategy. Such reception of energy is particularly advantageous in the case of energy supply modules which are designed as an energy storage module, e.g., as an accumulator module, battery module, capacitor module, or module for storing kinetic energy.

To achieve the object mentioned at the outset, a bearing, in particular a roller bearing or sliding bearing or linear bearing, is further proposed, with at least a first energy supply module and a second energy supply module, wherein a first control unit of the first energy supply module and a second control unit of the second energy supply module are configured to receive a supply request and, depending on the supply request and a given supply strategy, to control the delivery of energy by the respective energy supply module.

The same advantages can be achieved with the bearing as have already been described in connection with the method.

In addition, the advantageous features and configurations described in connection with the method can also be used alone or in combination in the device.

### BRIEF DESCRIPTION OF THE DRAWINGS

Further details and advantages will be explained below with reference to the exemplary embodiment shown in the drawings. Herein:

FIG. 1 shows a block diagram of a bearing with multiple energy supply modules.

### DETAILED DESCRIPTION

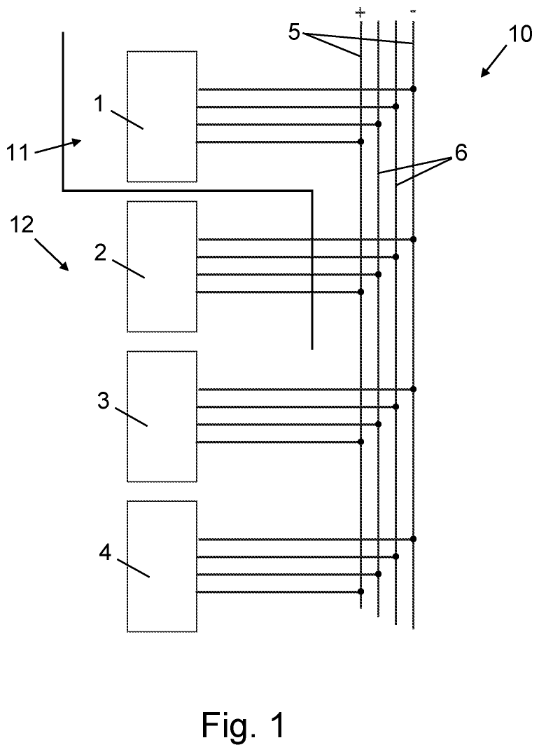

FIG. 1 shows a block diagram of the energy supply modules 1, 2, 3, 4 of a bearing 10 designed as a roller bearing. The bearing 10 has a plurality of energy supply modules 1, 2, 3, 4, which are designed differently.

A first energy supply module 1 is designed as an energy generation module. This energy generation module is an energy harvesting module that obtains electrical energy from vibrations in the bearing. To convert the energy, this energy harvesting module has a piezoelectric element. The first energy supply module 1 is arranged within the bearing 10, i.e., on one of the bearing rings of the bearing, cf. reference symbol 11.

A second energy supply module 2 is also designed as an energy generation module. It is an energy harvesting module that, like a generator, converts the kinetic energy of rotation of the roller bearing into electrical energy. This second energy supply module is designed as a module separate from the bearing rings of the bearing 10, cf. reference symbol 12.

A third energy supply module 3 is also designed as an energy generation module. It is an energy harvesting module that generates electrical energy according to the thermoelectric effect, i.e., it uses a temperature difference to generate an electrical current. In this respect, the energy harvesting module has a Peltier element. This third energy supply module 3 is likewise formed separately from the bearing rings of the bearing 10.

The fourth energy supply module 4 shown in FIG. 1 is designed as an energy storage module. This energy supply module 4 has an accumulator, which can be either charged or discharged. The fourth energy supply module 4 is also formed separately from the bearing rings of the bearing 10.

The energy supply modules 1, 2, 3, 4 of the bearing 10 are electrically connected to one another via a common supply bus 5, over which the energy supply modules 1, 2, 3, 4 can supply electrical energy. At least one load, for example a sensor or an actuator of the bearing, is also connected to the supply bus 5 and is supplied with energy via the supply bus.

In addition, the energy supply modules 1, 2, 3, 4 are connected to a common communication bus 6. The energy supply modules 1, 2, 3, 4 exchange information via this communication bus 6, as will be explained below.

The energy supply modules 1, 2, 3, 4 each have a control unit which controls the delivery of energy, and in the case of the energy supply module 4 designed as an energy storage module, also the reception of energy. The control units of the energy supply modules 1, 2, 3, 4 are configured such that they can control energy output or energy reception of the respective energy supply module in accordance with a predetermined supply strategy. This configuring can be carried out during the manufacture of the bearing or as part of an initialization procedure. The supply strategy can be stored in the control unit as a program or data code. Alternatively, the supply strategy can be determined by the structure of the hardware of the control unit. The supply strategy can be represented as a table and/or algorithm.

During operation of the bearing, a supply request is generated and sent to all energy supply modules 1, 2, 3, 4 via the communication bus 6. The supply request can include a voltage requirement and/or a current requirement and/or an energy requirement and/or a power requirement. It is either sent by a load of the bearing connected to the supply bus 5 or by an interface module. For example, if a load that requires a voltage of 3.3 V is to be activated, the power supply modules 1, 2, 3, 4 can be furnished with the supply request that a voltage of 3.3 V is required. Optionally, the supply request can additionally contain an energy and/or power requirement, for example that the load is to be provided with a specified power.

The control units of the energy supply modules 1, 2, 3, 4 receive this supply request and control the delivery of energy from their energy supply module 1, 2, 3, 4 depending on this supply request and possibly on other input variables. Other such input variables include supply status information of the other energy supply modules 1, 2, 3, 4, which the control unit also receives via the communication bus 6. This supply status information of the other energy supply modules 1, 2, 3, 4 indicates, for example, what voltage and/or what current and/or what power the other energy supply modules 1, 2, 3, 4 provide and/or what energy in the respective energy supply modules 1, 2, 3, 4 can be sent or received within a specified period of time. In addition, the control units can receive, as further input variables, prediction values of the other energy supply modules 1, 2, 3, 4, which the other energy supply modules 1, 2, 3, 4 have determined and which are characteristic of the future behavior of the respective energy supply module 1, 2, 3, 4.

The control units of the energy supply modules 1, 2, 3, 4 control the delivery of the energy by the respective energy supply module by setting an output voltage and/or an output current to a specific value or by deactivating the respective energy supply module 1, 2, 3, 4. For example, based on a supply strategy, it may be necessary to deactivate an energy supply module 1, 2, 3, 4, which is configured to generate a voltage in the range from 1 V to 4 V, if the supply request contains a voltage requirement that calls for a target voltage that is outside this range, for example 5 V. On the other hand, in the case of an energy supply module that, based on a supply strategy, is configured to generate a voltage in the range from 3 V to 8 V, the output voltage can be set to 5 V.

In the method described above for operating a bearing 10 with at least a first energy supply module 1 and a second energy supply module 2, a first control unit of the first energy supply module 1 and a second control unit of the second energy supply module 2 are configured to control the delivery of energy of the respective energy supply module 1, 2 according to a specified supply strategy, wherein the first control unit and/or the second control unit receives a supply request and controls the delivery of energy by the respective energy supply module 1, 2 depending on the supply request and the specified supply strategy. In this way, sufficient energy is supplied to the load by means of a scalable process with little effort.

### LIST OF REFERENCE SYMBOLS

1 Energy supply module
2 Energy supply module
3 Energy supply module
4 Energy supply module
5 Supply bus
6 Communication bus
10 Bearing
11 on the bearing ring
12 separately from the bearing ring

1. A method for operating a bearing with a first energy supply module and a second energy supply module, wherein a first control unit of the first energy supply module and a second control unit of the second energy supply module are configured to control the output of energy of the respective energy supply module in accordance with a specified supply strategy, wherein the first control unit and the second control unit receive a supply request and control the delivery of energy by the respective energy supply module depending on the supply request and on the specified supply strategy.

2. The method according to claim 1, wherein the first energy supply module and the second energy supply module are designed differently.

3. The method according to claim 1, wherein the supply request comprises a voltage requirement or a current requirement or an energy requirement and/or a power requirement.

4. The method according to claim 1, wherein the supply request is issued by a load module of the bearing.

5. The method according to claim 1, wherein the first control unit and the second control unit sets an output voltage or an output current for controlling the delivery of energy by the respective energy supply module.

6. The method according to claim 1, wherein the first energy supply module and the second energy supply module are connected via a common supply bus, over which the first energy supply module and the second energy supply module can deliver energy.

7. The method according to claim 1, wherein the first energy supply module determines supply status information which is characteristic of the first energy supply module and the supply status information is transmitted to the second energy supply module wherein the second control unit of the second energy supply module additionally controls the delivery of energy depending on the supply status information.

8. The method according to claim 1, wherein the first energy supply module determines a prediction value which is characteristic of the future behavior of the first energy supply module, and the prediction value is transmitted to the second energy supply module, wherein the second control unit additionally controls the delivery of energy depending on the predicted value.

9. The method according to claim 1, wherein the first control unit or the second control unit receives a supply request and, depending on the supply request and the specified supply strategy, controls the reception of energy by the respective energy supply module.

10. A bearing with at least a first energy supply module and a second energy supply module, a first control unit of the first energy supply module and a second control unit of the second energy supply module configured to receive a supply request and, depending on the supply request and a specified supply strategy, to control the delivery of energy by the respective energy supply module.

11. A bearing comprising:
a supply bus;
a communications bus;
a first energy supply module having a first control unit and configured to receive a supply request from a load via the communications bus and deliver energy to the load via the supply bus; and
a first energy supply module having a second control unit and configured to receive the supply request via the communications bus and deliver energy to the load via the supply bus;
wherein the first control unit and second control unit are configured to control delivery of the energy in accordance with a predetermined supply strategy depending on the supply request.

12. The bearing according to claim 11, wherein the first energy supply module and the second energy supply module acquire energy via different physical phenomena.

13. The bearing according to claim 11, wherein:
the first energy supply module determines supply status information which is characteristic of the first energy supply module and transmits the supply status information to the second energy supply module; and
the second control unit of the second energy supply module additionally controls the delivery of energy depending on the supply status information.

14. The bearing according to claim 13, wherein:
the first energy supply module determines a prediction value which is characteristic of the future behavior of the first energy supply module and transmits the prediction value to the second energy supply module; and
the second control unit additionally controls the delivery of energy depending on the predicted value.

15. The bearing according to claim 1, wherein the second supply module is a storage module and the second control unit further controls reception of energy by the second supply module from the supply bus.
